(19) United States
(12) Patent Application Publication
(10) Pub. No.: US 2007/0126333 A1
(43) Pub. Date: Jun. 7, 2007

(54) Cathode ray tube

(76) Inventors: Shigeo Nakatera, Hirakata-shi (JP); Yoko Kannan, Ebina-shi (JP)

Correspondence Address: SNELL & WILMER L.L.P. (Matsushita), 600 ANTON BOULEVARD, SUITE 1400, COSTA MESA, CA, 92626, US

(21) Appl. No.: 10/561,723

(22) PCT Filed: Jul. 6, 2004
(86) PCT No.: PCT/JP04/09895

§ 371 Date: Sep. 6, 2006

(30) Foreign Application Priority Data
Jul. 10, 2003 (JP) 2003-272998

(51) Int. Cl. H01J 29/86; H01J 29/88; H01J 29/92

(52) U.S. Cl. 313/479; 313/477 R

(57) ABSTRACT

In an internal magnetic shield (28) that is substantially in a shape of a hollow truncated pyramid which is rectangular in a cross section, and has a small diameter opening on the side of an electron gun, the short edges (52 and 54) at the small diameter opening are formed in the shape of an inverted trapezoid that drops toward the panel, and the long edges (56 and 58) are formed in the shape of an obtuse-angled isosceles triangle that rises toward the electron gun.

### TECHNICAL FIELD

The present invention relates to a cathode ray tube, and more specifically relates to a cathode ray tube that includes an internal magnetic shield.

### BACKGROUND ART

Electron beams emitted from an electron gun may deviate from the intended trajectories due to the influence of external magnetic fields such as the terrestrial magnetism. In the case of a color cathode ray tube, the deviation may result in mislanding of three electron beams on the phosphor screen, which causes color drifts.

To avoid such mislanding of electron beams, an internal magnetic shield, which is substantially in the shape of a hollow truncated pyramid, is disposed to surround the paths of the electron beams (see, for example, Japanese Laid-Open Patent Application No. 58-178945).

However, although such an internal magnetic shield can effectively shield external magnetic fields that would enter in the horizontal and vertical directions, it cannot completely shield external magnetic fields that would enter in the tube-axis direction. This is because it is necessary to open the front and back of the internal magnetic shield in the tube axis direction to secure the electron beam trajectories from the electron gun to the phosphor screen. A shadow mask, which is disposed between the phosphor screen and an opening of the internal magnetic shield on the side of the phosphor screen, plays a role of a magnetic shield. However, no member for shielding magnetic fields is disposed between the electron gun and an opening of the internal magnetic shield on the side of the electron gun.

Meanwhile, in the case of a color cathode ray tube adopting a stripe phosphor screen, the color drifts are especially affected greatly by mislanding in the horizontal direction. That is to say, what matters most is the horizontal component of the Lorentz force that is received by the electron beams.

The horizontal component “Fx” is represented by the following equation.
Fx=e(By×Vz−Bz×Vy) (1)

In the above equation (1), “e” indicates the quantity of electric charge of electron; “By” indicates the magnetic flux density in the Y-axis direction (vertical direction); “Bz” indicates the magnetic flux density in the Z-axis direction (tube-axis direction); “Vz” indicates the speed of electron beam in the Z-axis direction; and “Vy” indicates the speed of electron beam in the Y-axis direction.

Among the elements that determine “Fx” in the equation (1), “e” cannot be varied, and there is little room for varying “Vz” and “Vy”. Accordingly, to decrease “Fx”, the balance between “By” and “Bz” needs to be adjusted.

When, for example, a cathode ray tube is placed such that the tube-axis direction matches the north-south direction, “Bz” takes the largest value due to the terrestrial magnetism that is not shielded by the internal magnetic shield, and at the same time, “Fx” takes the largest value since “By” is smaller than “Bz” in the nature of things, and the largest amount of color drifts occurs.

In such a case, it is possible to decrease “Fx” and reduce the amount of color drifts by adjusting “By” and “Bz” to increase a ratio of “By” to “Bz”.

Conventionally, various shapes of the magnetic shield have been contrived to realize the adjustment.

FIG. 1 shows an example of such. As shown in FIG. 1, an internal magnetic shield 200 is composed of long side plates 202 and 204 facing each other along the vertical direction and short side plates 206 and 208 facing each other along the horizontal direction, the side plates all being joined together to form substantially a shape of a hollow truncated pyramid. Each of the short side plates 206 and 208 is cut at a portion on the side of the electron gun in the shape of an inverted trapezoid, and the cut is referred to as a cut 210.

When a cathode ray tube having the internal magnetic shield 200 is placed such that the tube-axis direction matches the north-south direction, the internal magnetic shield 200 is magnetized by the terrestrial magnetism. The magnetization causes magnetic poles to appear at the rim of the opening on the side of the electron gun and in the vicinity thereof. Here, if the demagnetization process (the degaussing process in which an attenuating alternating magnetic field is generated bypassing an attenuating alternating current through a demagnetization coil that is disposed outside the cathode ray tube) is performed, the magnetic poles are enhanced and the internal magnetic shield is magnetized in a direction that eliminates the external magnetic field (terrestrial magnetism). In the figure, an area in which the magnetic poles appear is indicated by half tone dot meshing. Among the magnetic fluxes in the electron beam passing area, a magnetic flux in the vicinity of a corner of the opening on the side of the electron gun is represented by a combination of vectors of (i) a magnetic flux generated by a magnetic pole that appears in a region including an oblique side 210A and the vicinity thereof and (ii) a magnetic flux of the external magnetic field (terrestrial magnetism), and the magnetic flux in the vicinity of the corner goes upward or downward (in the Y-axis direction). This increases the ratio of “By” to “Bz”, decreases “Fx”, and reduces the amount of color drifts in the vicinity of a corner the screen.

However, although the internal magnetic shield 200 is effective in reducing the amount of color drifts in the vicinity of the screen corners, it hardly contributes to the reduction of the amount of color drifts in the vicinity of the central upper and lower end portions of the screen.

The object of the present invention is therefore to provide a cathode ray tube that is capable of reducing the amount of color drifts in the vicinity of the central upper and lower end portions of the screen, as well as in the vicinity of the screen corners.

### DISCLOSURE OF THE INVENTION

The present invention is achieved as a cathode ray tube comprising: a glass bulb that is formed by joining a substantially rectangular panel with a funnel that houses an electron gun in a neck thereof; and an internal magnetic shield that is substantially in a shape of a hollow truncated pyramid which is rectangular in a cross section, the internal magnetic shield being housed in the glass bulb such that a small diameter opening of the internal magnetic shield faces toward the electron gun, wherein in the internal magnetic shield, a first short edge and a second short edge are arranged to face each other across the small diameter opening, and each short edge is in a shape of a valley that drops toward the panel, and a first long edge and a second long edge are arranged to face each other across the small diameter opening, and each long edge is in a shape of a mountain that rises toward the electron gun.

With the above-described construction, it is possible to reduce the amount of color drifts in the vicinity of the central upper and lower end portions of the panel (screen), as well as in the vicinity of the panel (screen) corners.

In the above-stated cathode ray tube, the internal magnetic shield may be structured such that in terms of a height of the internal magnetic shield from a plane that is perpendicular to a tube axis of the cathode ray tube and includes a point at an intersection of an inner surface of the panel with the tube axis, tops of the long edges in the shape of the mountain have a largest height, points where long edges meet short edges have a smaller height than the tops of the long edges, and bottoms of the short edges in the shape of the valley have a smaller height than the points where the long edges meet the short edges.

In the above-stated cathode ray tube, at a rim of the small diameter opening, the height of the internal magnetic shield from the plane may decrease gradually from the tops of the long edges to the bottoms of the short edges.

### BRIEF DESCRIPTION OF THE DRAWING

FIG. 1 is a perspective view of a magnetic shield assembly of a conventional technology.

FIG. 2 is a cross-sectional view of a color cathode ray tube apparatus in an embodiment of the present invention.

FIG. 3 is a perspective view of a magnetic shield assembly in the color cathode ray tube apparatus.

FIGS. 4A and 4B are respectively a front view and a bottom view of a model of an internal magnetic shield that constitutes the magnetic shield assembly in the embodiment of the present invention.

FIGS. 5A and 5B are respectively a front view and a bottom view of an internal magnetic shield of a conventional technology.

FIG. 6 shows changes of a ratio of the vertical component of the magnetic flux density to the tube axis component over the electron beam trajectory.

FIG. 7 shows measurement positions of the electron beam mislanding.

FIG. 8 shows the measurement results of the amount of electron beam mislanding in the horizontal direction measured at several positions of the screen when external magnetic fields were produced to influence a color cathode ray tube in the tube axis direction.

FIGS. 9A and 9B are respectively a front view and a bottom view of a model of an internal magnetic shield of a modification.

FIGS. 10A and 10B are respectively a front view and a bottom view of a model of an internal magnetic shield of a modification.

FIGS. 11A and 11B are respectively a front view and a bottom view of a model of an internal magnetic shield of a modification.

FIGS. 12A and 12B are respectively a front view and a bottom view of a model of an internal magnetic shield of a modification.

FIGS. 13A and 13B are respectively a front view and a bottom view of a model of an internal magnetic shield of a modification.

FIGS. 14A and 14B are respectively a front view and a bottom view of a model of an internal magnetic shield of a modification.

FIGS. 15A and 15B are respectively a front view and a bottom view of a model of an internal magnetic shield of a modification.

### BEST MODE FOR CARRYING OUT THE INVENTION

The following describes an embodiment of the present invention with reference to the attached figures.

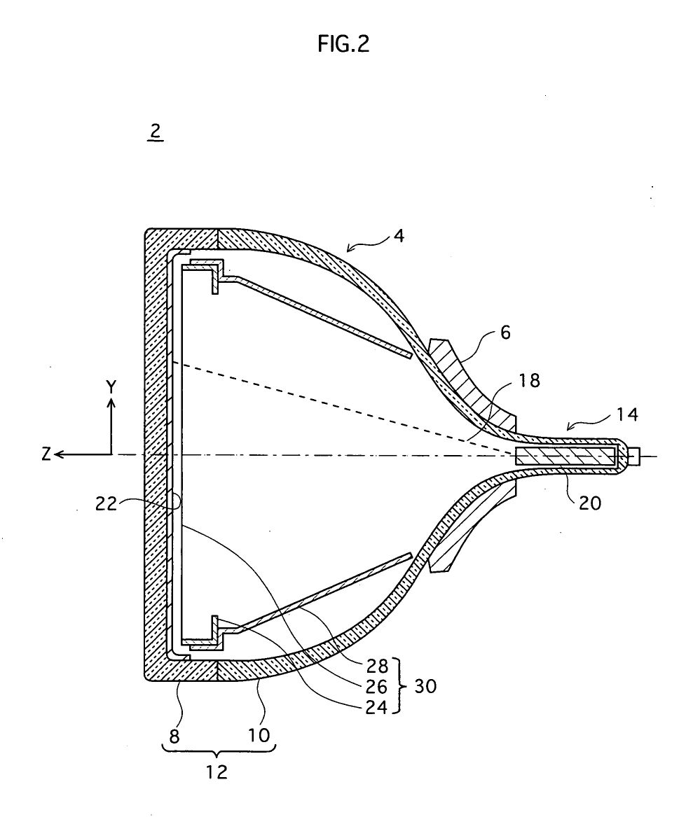

FIG. 2 is a cross-sectional view of a color cathode ray tube apparatus 2 of the present embodiment that roughly shows the structure thereof. The color cathode ray tube apparatus 2 is a color cathode ray tube apparatus that is “4:3” in aspect ratio and 29 inches in diagonal length.

As shown in FIG. 2, the color cathode ray tube apparatus 2 includes a color cathode ray tube 4 and a deflection yoke 6.

In the present specification, an X-Y-Z orthogonal coordinate system is defined as follows: the tube axis of the color cathode ray tube 4 is the Z axis; an axis that is perpendicular to the Z axis in the horizontal direction is the X axis (not illustrated in FIG. 2); and an axis that is perpendicular to the Z axis in the vertical direction is the Y axis. Also, in the present specification, the tube axis (Z axis) is used as a boundary between “upper” and “lower”, and is used as a boundary between “left” and “right” when viewed from the panel.

The color cathode ray tube 4 includes a glass bulb 12 that is formed by joining a glass panel 8 that is substantially in the shape of a rectangle with a glass funnel 10 (the glass panel 8 and the glass funnel 10 are hereinafter merely referred to as a panel 8 and a funnel 10, respectively).

In a neck 14 of the funnel 10, an inline-type electron gun 20 is housed. The electron gun 20 emits, in the tube-axis direction, three electron beams 18, which respectively correspond to R (red), G (green), and B (blue), with regular intervals in the horizontal direction.

On the inner surface of the panel 8, a phosphor screen 22, which is composed of red, green, and blue phosphors that are applied (arranged) to form vertical stripes, is formed.

Also, a shadow mask 26, which is a color selection electrode, is disposed substantially in parallel with the phosphor screen 22, supported by a rectangular frame 24. The shadow mask 26 is a tension mask made of iron that is tensioned in the vertical direction. It should be noted here that the shadow mask may be a pressed mask that is not tensioned.

Although not illustrated, a pair of demagnetization coils are provided on the outer surface of the glass funnel 10 to face each other along the vertical direction. By passing an attenuating alternating current through the demagnetization coils so that an attenuating alternating magnetic field is generated, it is possible to generate, in a magnetic shield assembly which will be described later, a magnetization that reduces the effect of the external magnetism (terrestrial magnetism) (degaussing process).

The deflection yoke 6, which is provided on the outer surface of the glass funnel 10, deflects the three electron beams 18 emitted from the electron gun 20 upward, downward, leftward, and rightward to allow the electron beams to scan the phosphor screen 22 by the raster scan method.

An internal magnetic shield 28, supported by the frame 24, is housed in the glass bulb 12 so as to surround the paths of the electron beams 18.

Here, an assembly of the internal magnetic shield 28, frame 24, and shadow mask 26 is referred to as a magnetic shield assembly 30. A hot rolled steel sheet is used for the frame 24, and soft iron is used for the internal magnetic shield 28.

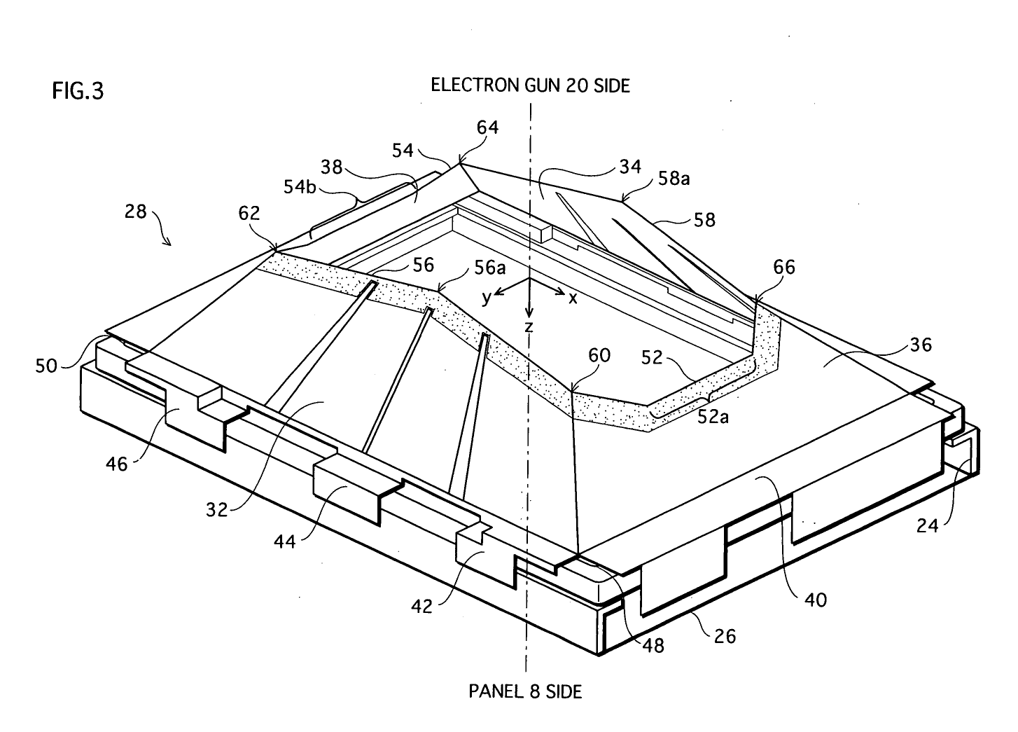

FIG. 3 is a perspective view of the magnetic shield assembly 30. It should be noted here that to avoid complication, the shadow mask 26 is represented only by its outline in FIG. 3.

As shown in FIG. 3, the internal magnetic shield 28 is substantially in a shape of a hollow truncated pyramid which is rectangular in a cross section. That is to say, the internal magnetic shield 28 is structured such that a pair of long side plates 32 and 34, which are arranged to face each other along the vertical direction, and a pair of short side plates 36 and 38, which are arranged to face each other along the horizontal direction, are joined together to form planes of a pyramid whose top is cut.

Skirts 40, 42, 44, 46, . . . extend from the rim of a large diameter opening of the internal magnetic shield 28 that is substantially in a shape of a hollow truncated pyramid. The internal magnetic shield 28 is joined with the frame 24 at the skirts 40, . . . by spot welding. Also, rectangular electron shield plates 48 and 50 are disposed between the frame 24 and horizontal-direction edges of the internal magnetic shield 28. The electron shield plates 48 and 50 shield the electron beams that have overscanned the horizontal-direction edges.

Edges 52 and 54 of short side plates 36 and 38 on the side of the electron gun 20 (hereinafter, the edges are referred to as “short edges”) are formed in the shape of a valley, more specifically in the shape of an inverted trapezoid that drops toward the panel 8.

On the other hand, edges 56 and 58 of long side plates 32 and 34 on the side of the electron gun 20 (hereinafter, the edges are referred to as “long edges”) are formed in the shape of a mountain, more specifically in the shape of an obtuse-angled isosceles triangle.

The short edges 52 and 54 and the long edges 56 and 58 are continuous to each other, without steps formed at junctions 60, 62, 64, and 66. In addition, in terms of a height in the tube axis direction from a hypothetical plane (X-Y plane) that includes a point at an intersection of the inner surface of the panel 8 with the tube axis and is perpendicular to the tube axis, tops 56a and 58a of the long edges 56 and 58 (the tops 56a and 58a have the same height) have the largest height, the junctions 60, 62, 64, and 66 (the junctions 60, 62, 64, and 66 have the same height) have a smaller height than the tops 56a and 58a, and bottoms 52a and 54b of the short edges 52 and 54 (the bottoms 52a and 54b have the same height) have the smallest height. Further, at the rim of the small diameter opening, the height in the tube axis direction from the hypothetical plane decreases gradually from the tops 56a and 58a to the bottoms 52a and 54b.

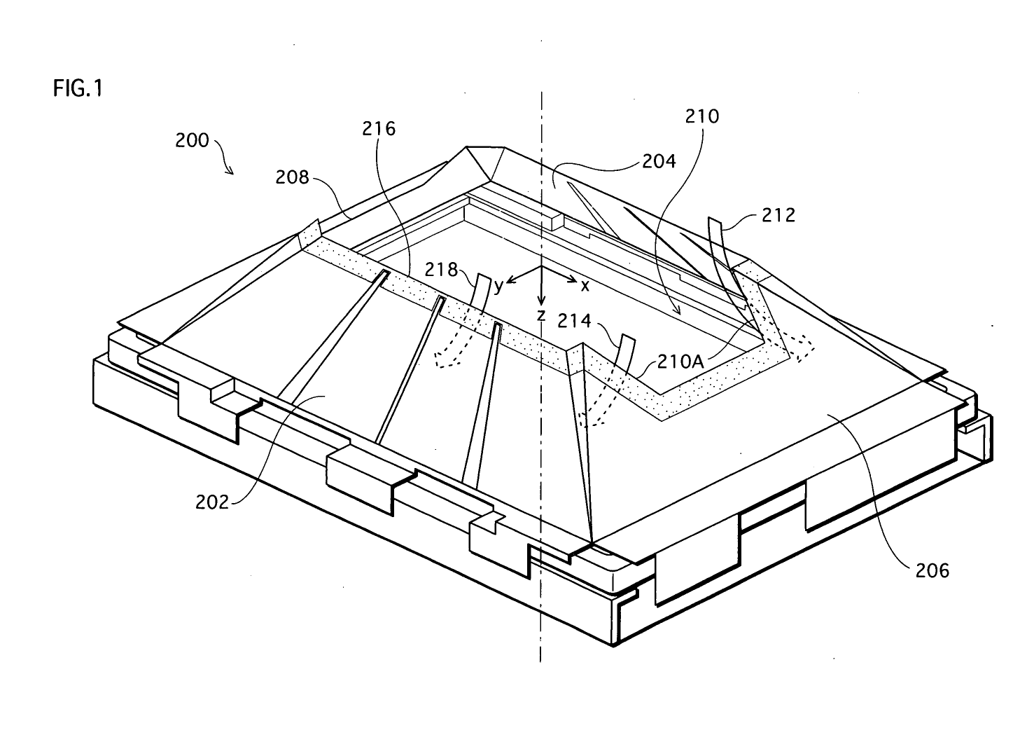

With the color cathode ray tube 4 including the internal magnetic shield 28 structured as described above, the amount of color drifts is reduced not only at the four corners of the screen, but at the central upper end portion and central lower end portion of the screen. This will be explained in comparison with the color cathode ray tube including the conventional internal magnetic shield 200 that is shown in FIG. 1.

When a color cathode ray tube is placed such that the tube-axis direction matches the north-south direction, the magnetic fluxes that enter the internal magnetic shield by the terrestrial magnetism take the largest values. Also, the internal magnetic shield placed in the terrestrial magnetism is magnetized. In this case, either of the magnetic north pole and the magnetic south pole appears in the vicinity of the rim of the internal magnetic shield surrounding the small diameter opening. Also, by performing the degaussing process, which was described earlier, the magnetic poles are enhanced and the internal magnetic shield is magnetized in a direction that eliminates the terrestrial magnetism. In FIGS. 3 and 1, an area in which the magnetic poles appear is indicated by half tone dot meshing.

In the internal magnetic shield shown in FIGS. 3 and 1, among the lines of magnetic force that enter the internal magnetic shield from the small diameter opening, lines of magnetic force that pass near the rim of the opening are largely influenced by the magnetic forces generated by the magnetic poles, and are bent toward the magnetic poles.

Here, since the lines of magnetic force enter the internal magnetic shield in the tube axis direction, the longer the influence of a magnetic pole in the tube axis direction is (the longer the distance is), the more the line of magnetic force is bent due to the integration effect.

In the case of the conventional internal magnetic shield 200 shown in FIG. 1, the flows of the magnetic fluxes 212 and 214 in the vicinity of corners of the small diameter opening are influenced over long distances along the tube axis direction (the integration effect) due to magnetic poles that appear in the vicinity of the oblique edges 210A, and are bent vertically upward and downward. That is to say, in the equation (1), “Bz” decreases and “By” increases as much.

This will be explained in other terms.

Each of the magnetic fluxes that are observed in the vicinity of the internal magnetic shield is represented as a combination of the following (a combination of vectors): (i) a magnetic flux generated by a magnetic pole that appears at the edge of the internal magnetic shield and (ii) a magnetic flux of the terrestrial magnetism. Of these, the magnetic fluxes that are observed in the vicinity of corners of the internal magnetic shield are bent vertically upward and downward as they face the internal magnetic shield, for the above-stated reasons. In the internal magnetic shield shown in FIG. 3 or FIG. 1, the oblique edges 210A (FIG. 1) extend from corners of the opening on the side of the electric gun substantially in the tube axis direction. As a result, magnetic poles are formed over a long distance that extends substantially along the tube axis.

Therefore, the value of “By” in the equation (1) increases due to the integration effect. In other words, part of “Bz₀” is converted into “By” under the influence of the above-stated magnetic poles, where “Bz₀” represents the tube axis component of a magnetic flux generated by the terrestrial magnetism that is not under influence of the internal magnetic shield.

As a result of this, “Fx” is reduced, and the amount of color drifts near the corners of the screen is reduced.

On the other hand, a magnetic flux 218 near the center of a long edge 216 is bent vertically upward under the influence of magnetic poles that appear in the vicinity of the long edge 216. However, since the distance in the tube axis direction over which the magnetic flux 218 is influenced is short, a small percentage of “Bz₀” is converted into “By” (that is to say, the integration value of “By” is small).

Accordingly, the amount of color drifts in the vicinity of the central upper and lower end portions of the screen is not much reduced. It should be noted here that the magnetic flux 218 is not much influenced by the magnetic poles in the vicinity of the oblique sides 210A, since the magnetic flux 218 is far away from the oblique sides 210A.

In contrast, in the internal magnetic shield 28, the amount of color drifts is reduced not only in the vicinity of the corners of the screen, but in the vicinity of the central upper and lower end portions of the screen. The internal magnetic shield 28 enables the amount of color drifts to be reduced in the vicinity of the corners of the screen for basically the same reason as the conventional magnetic shield, and the description of the reason is omitted here.

In FIG. 3, a magnetic flux that enters the internal magnetic shield passing near the center of a long edge 56 is bent vertically upward under the influence of magnetic poles that appear in the vicinity of the long edge 56. Furthermore, the long edge 56 rises toward the electron gun 20 to be in a shape of an obtuse-angled isosceles triangle. Accordingly, the magnetic flux is under the influence of the magnetic poles substantially over a length that corresponds to the height of the obtuse-angled isosceles triangle. Accordingly, a large percentage of “Bz₀” is converted into “By” (that is to say, the integration value of “By” is large), and the amount of color drifts in the vicinity of the central upper and lower end portions of the screen is reduced compared with the conventional one.

The inventors of the present invention measured the values of “By” on the trajectories of electron beams that reached the central lower end portion of the screen to confirm the distribution of “By” (the effect of conversion from “Bz₀” to “By”), for comparison between the internal magnetic shield 28 of the present embodiment and the conventional internal magnetic shield 200.

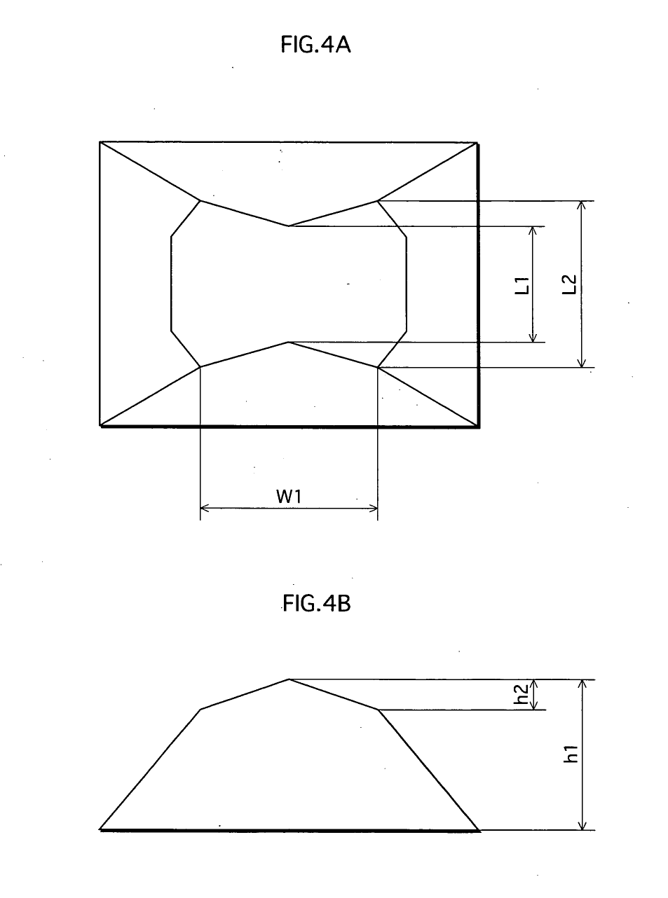

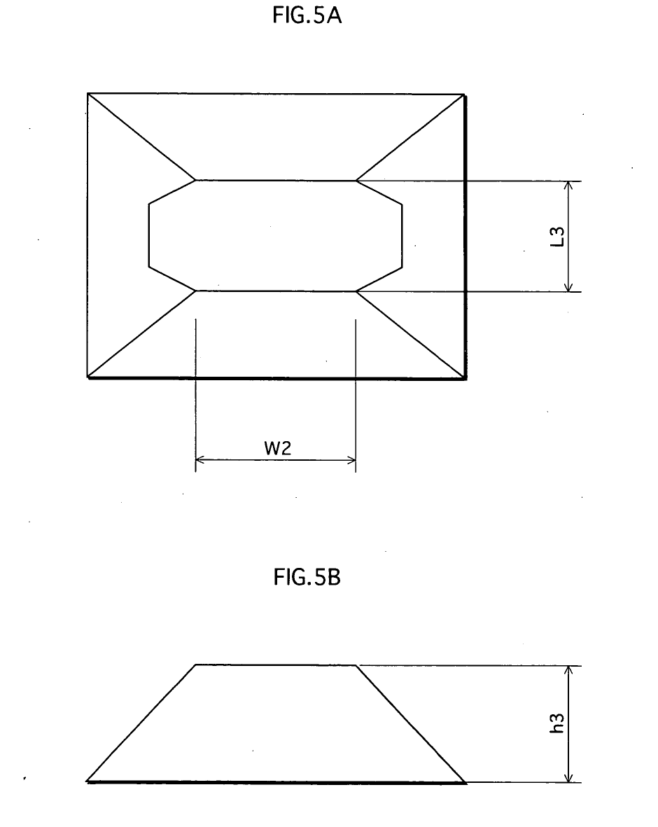

FIGS. 4A and 4B and FIGS. 5A and 5B show models of the internal magnetic shields that were used for the measurements.

FIGS. 4A and 4B show a model of the internal magnetic shield 28 of the embodiment shown in FIG. 3. FIG. 4a is a front view and FIG. 4b is a bottom view. The measurements indicated in FIGS. 4A and 4B are as follows: L1=120 mm; L2=170 mm; W1=236 mm; h1=150 mm; and h2=30 mm.

FIGS. 5A and 5B show a model of the conventional internal magnetic shield 200 shown in FIG. 1. FIG. 5A is a front view and FIG. 5B is a bottom view. The measurements indicated in FIGS. 5A and 5B are as follows: L3=140 mm; W2=200 mm; and h3=150 mm.

Both the internal magnetic shield 28 of the present embodiment and the conventional internal magnetic shield 200 are made of soft iron. The both types of internal magnetic shields were respectively joined with frames to which shadow masks (tension masks) were attached, to form magnetic shield assemblies, and then the both types of magnetic shield assemblies were subjected to the measurement. It should be noted here that the same frame and shadow mask were used for both types of internal magnetic shields. Also, the degaussing process, which was described earlier, was performed before the measurement.

Magnetic fields were produced to influence the both types of magnetic shield assemblies in the tube axis direction, and the values of “By” on the trajectories of electron beams that reached the central lower end portion of the screen were measured. And then a graph was made based on the calculated values of a ratio (%) of “By” to “Bz₀” (“Bz₀” represents the tube axis component of the terrestrial magnetism that is not under the influence of the magnetic shield) (hereinafter, such a tube axis component of the terrestrial magnetism is referred to as a terrestrial magnetism tube axis component).

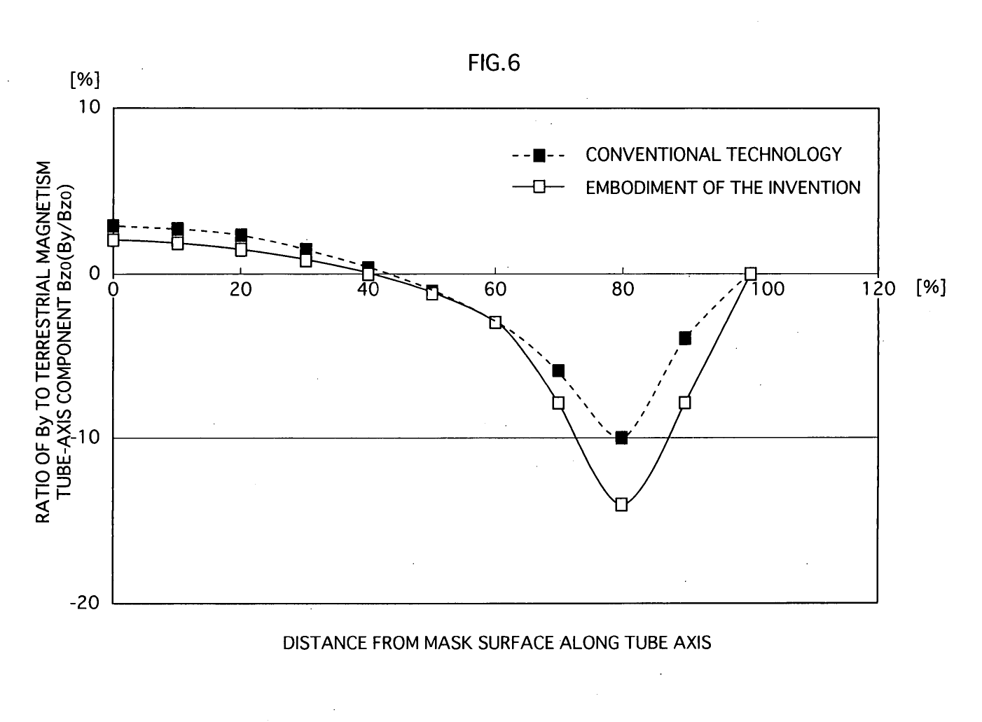

FIG. 6 shows the obtained graph.

In FIG. 6, the vertical axis represents a percentage of the vertical component “By” in the terrestrial magnetism tube axis component “Bz₀” [(By/Bz₀)×100]. The reason why the percentage takes negative values is that positive values represent upward direction and negative values represent downward direction.

The horizontal axis indicates a distance along the tube axis from the mask surface (0%) toward the electron gun when the distance, with reference to the shadow mask, from the mask surface to the center of deflection of electron beams is presumed to be 100%. It should be noted here that the distance ranging from 0% to 80% is surrounded by a magnetic shield assembly.

FIG. 6 indicates that in both the internal magnetic shield 28 of the present embodiment and the conventional internal magnetic shield 200, the values of “By” start to drastically increase as negative values from approximately 20% before the entrance of the internal magnetic shields (the position of 100% in the graph) . This is a result of the influence of the magnetic poles. However, the amount of the increase is larger in the internal magnetic shield 28 of the present embodiment than in the conventional internal magnetic shield 200.

An electron beam, until it reaches the phosphor screen, continues to receive the Lorentz force that is produced by external magnetic fields such as the terrestrial magnetism. The amount of the mislanding on the phosphor screen is therefore determined by the accumulated amount of the received Lorentz force. In regards with the horizontal direction, the amount of mislanding is determined by the integration value of “Fx”, namely the horizontal component of the Lorentz force that is received by an electron beam on a trajectory from the center of deflection to the phosphor screen. As shown in FIG. 6, there is a great difference between the conventional internal magnetic shield 200 and the internal magnetic shield 28 of the present embodiment in the value of “By” over the distance between 100% and 55%. This results in a difference in the amount of mislanding, and further results in the reduction of the amount of color drifts.

The inventors of the present invention performed experimental measurement of the amount of mislanding of electron beams in the horizontal direction on the screen (phosphor screen).

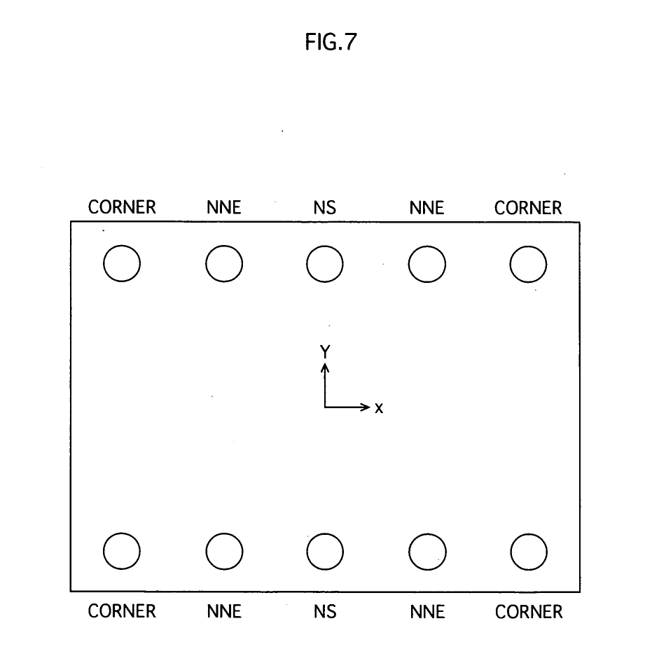

The measurement positions are screen corners (hereinafter merely referred to as “corners”), central upper and lower end portions of the screen (hereinafter referred to as “NSs”), and intermediate positions between the corners and the NSs (hereinafter referred to as “NNEs”), as shown in FIG. 7.

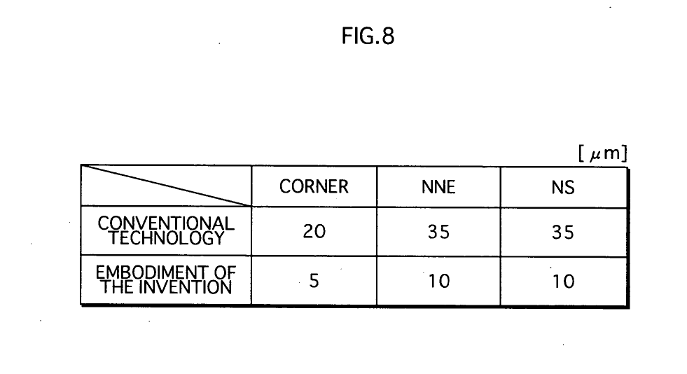

FIG. 8 shows the measurement results of the amount of mislanding measured at the above-mentioned positions when external magnetic fields were produced to influence a color cathode ray tube in the tube axis direction.

As apparent from FIG. 8, the amount of color drifts has been reduced at the NNEs and corners, as well as at the NSs.

Also, external magnetic fields were produced to influence a color cathode ray tube in the horizontal direction (X-axis direction), and the amount of mislanding in the horizontal direction was measured at the corners. The measurement result was 20 μm for both of the internal magnetic shield 28 of the present embodiment and the conventional internal magnetic shield 200.

The color cathode ray tube of the present embodiment provides the following advantageous effect, as well as the above-described advantageous effect of reducing the amount of color drifts.

That is to say, due to the capability of reducing the amount of electron beam mislanding that is caused by the terrestrial magnetism, it is possible for the color cathode ray tube of the present embodiment to improve the brightness contrast by reducing the guard band width for the black matrix.

In general, as a method for reducing the amount of electron beam mislanding that is caused by the terrestrial magnetism, the shadow mask (color selection electrode) is increased in thickness so as to improve the tube axis magnetic field shield effect of the whole magnetic shield assembly. In contrast, in the present embodiment, the internal magnetic shield is devised to reduce the amount of electron beam mislanding that is caused by the tube axis magnetic field. This makes it possible to reduce the thickness of the shadow mask as much. This improves the rate of electron beams that pass through the shadow mask, increasing the brightness. This also allows the shadow mask to be decreased in thickness. The decreased thickness facilitates forming the holes by etching, enabling finely pitched holes or low-cost shadow mask to be achieved.

Up to now, the present invention has been described based on the embodiments. However, not limited to the embodiments, the present invention can be modified in proper ways within a range that does not depart the scope of the present invention. In particular, the opening of the internal magnetic shield on the side of the electron gun (the small diameter opening) may be modified in various ways.

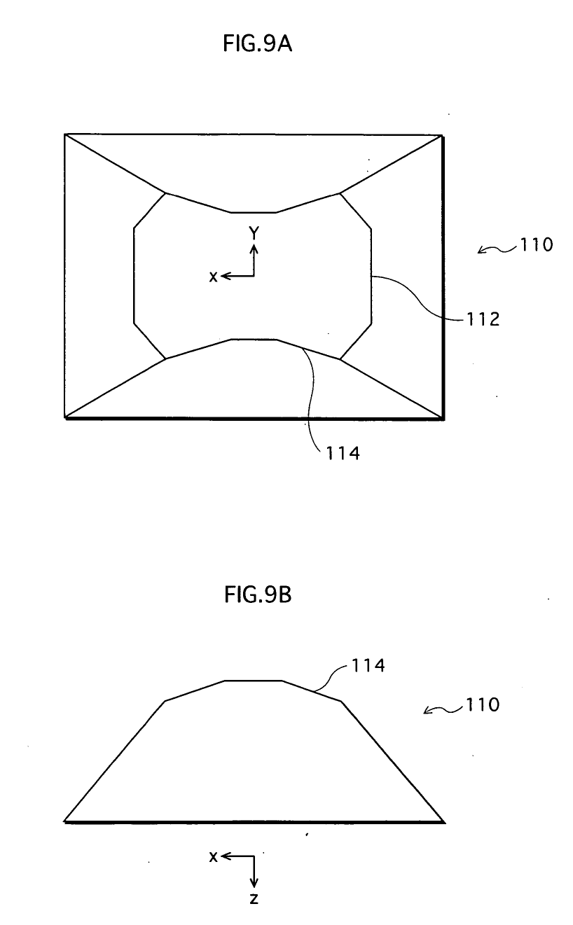

The above-suggested modifications are shown in FIGS. 9A and 9B to FIGS. 14A and 14B. In each pair of figures, figure A is a front view and figure B is a bottom view. These figures are drawn in the same manner as FIGS. 4A and 4B.

(1) In an internal magnetic shield 110 shown in FIGS. 9A and 9B, each short edge 112 is formed in the shape of an inverted trapezoid that drops toward the electron gun, and each long edge 114 is formed in the shape of a trapezoid that rises toward the panel.

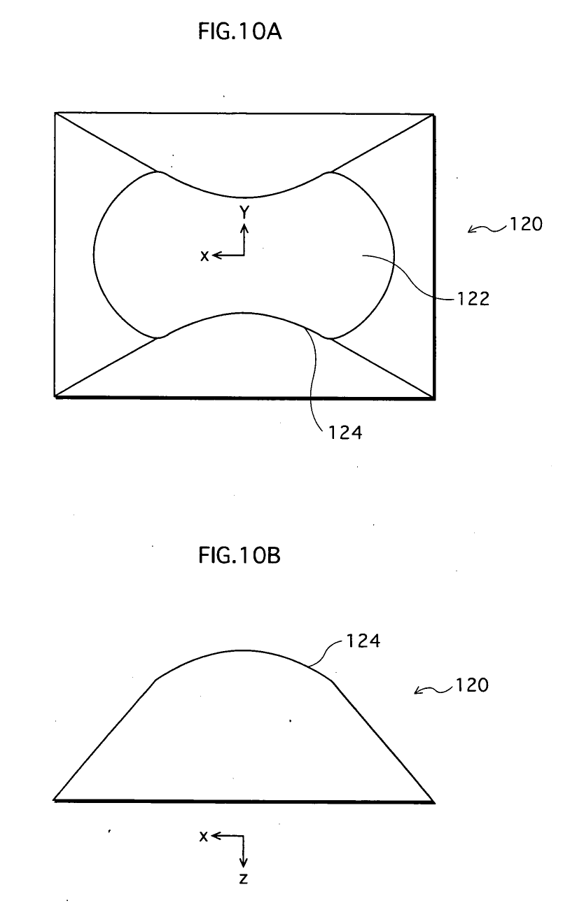

(2) In an internal magnetic shield 120 shown in FIGS. 10A and 10B, each short edge 122 is formed in the shape of character “U” (or an arch) that drops toward the electron gun, and each long edge 124 is formed in the shape of an arc that rises toward the panel.

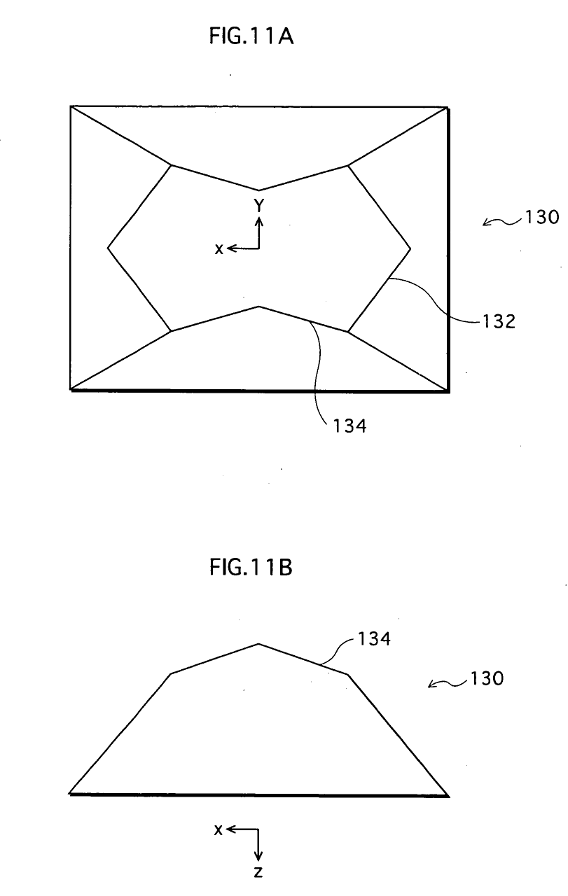

(3) In an internal magnetic shield 130 shown in FIGS. 11A and 11B, each short edge 132 is formed in the shape of character “V” that drops toward the electron gun, and each long edge 134 is formed in the shape of an obtuse-angled isosceles triangle.

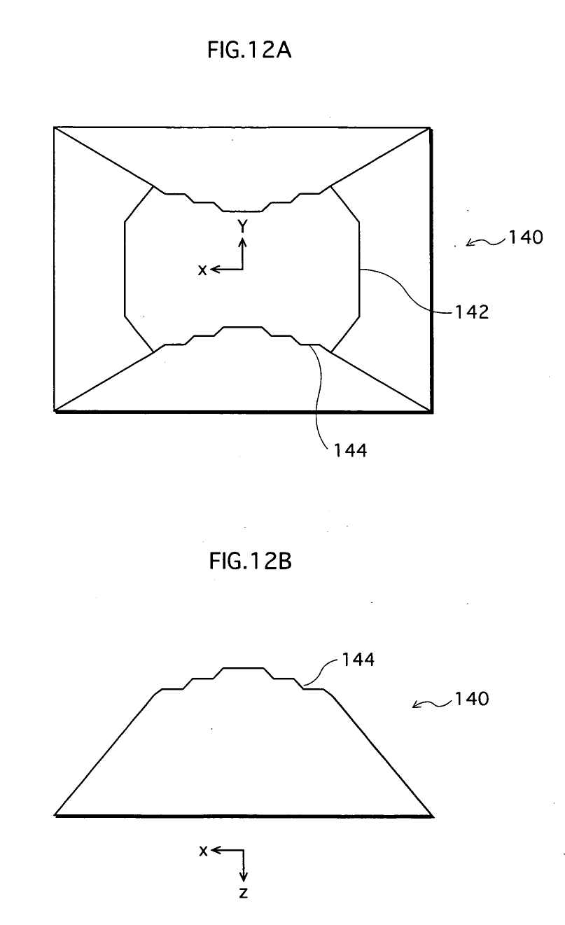

(4) In an internal magnetic shield 140 shown in FIGS. 12A and 12B, each short edge 142 is formed in the shape of an inverted trapezoid that drops toward the electron gun, and each long edge 144 is formed in the shape of a staircase that rises toward the panel.

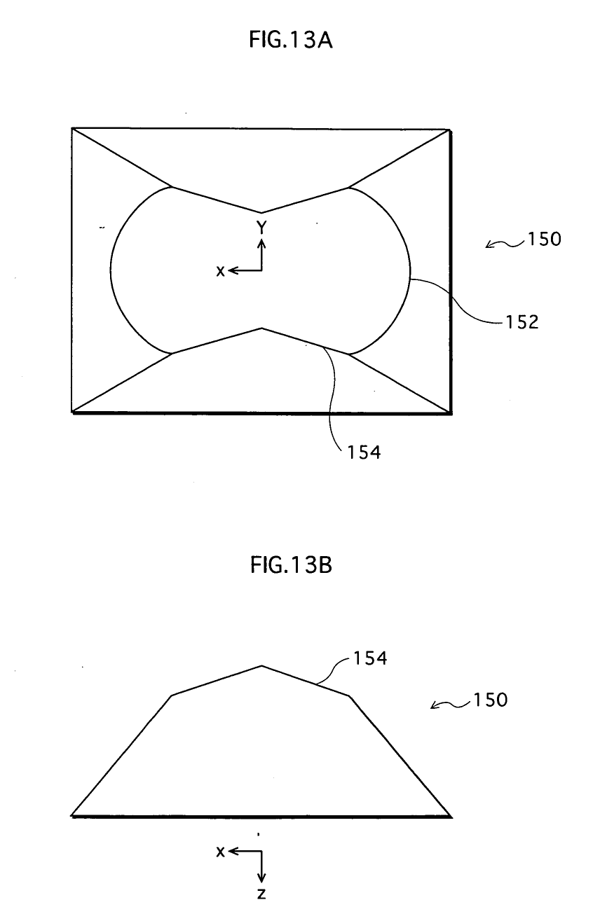

(5) In an internal magnetic shield 150 shown in FIGS. 13A and 13B, each short edge 152 is formed in the shape of character “U” (or an arch) that drops toward the electron gun, and each long edge 154 is formed in the shape of an obtuse-angled isosceles triangle.

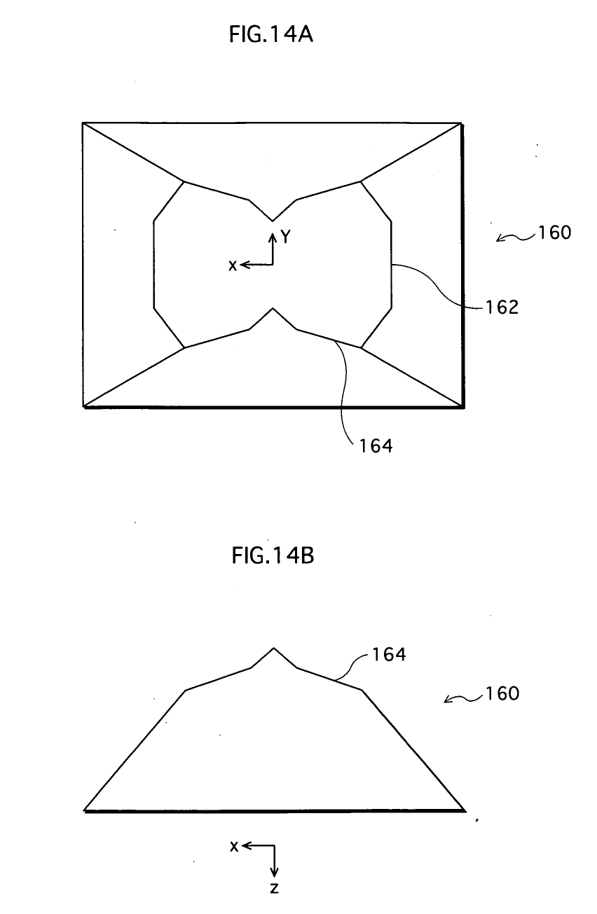

(6) In an internal magnetic shield 160 shown in FIGS. 14A and 14B, each short edge 162 is formed in the shape of an inverted trapezoid that drops toward the electron gun, and each long edge 164 is formed in the shape of a double-triangle mountain that rises toward the panel. That is to say, each long edge 164 is in a shape that is formed by cutting the apex of an obtuse-angled isosceles triangle in a direction parallel to the bottom thereof, and then putting an isosceles triangle whose apex angle is smaller (steeper) than that of the obtuse-angled isosceles triangle onto the apex-less obtuse-angled isosceles triangle, so that the bottom of the small-apex-angle triangle fits the top of the apex-less obtuse-angled isosceles triangle, as shown in FIGS. 14A and 14B.

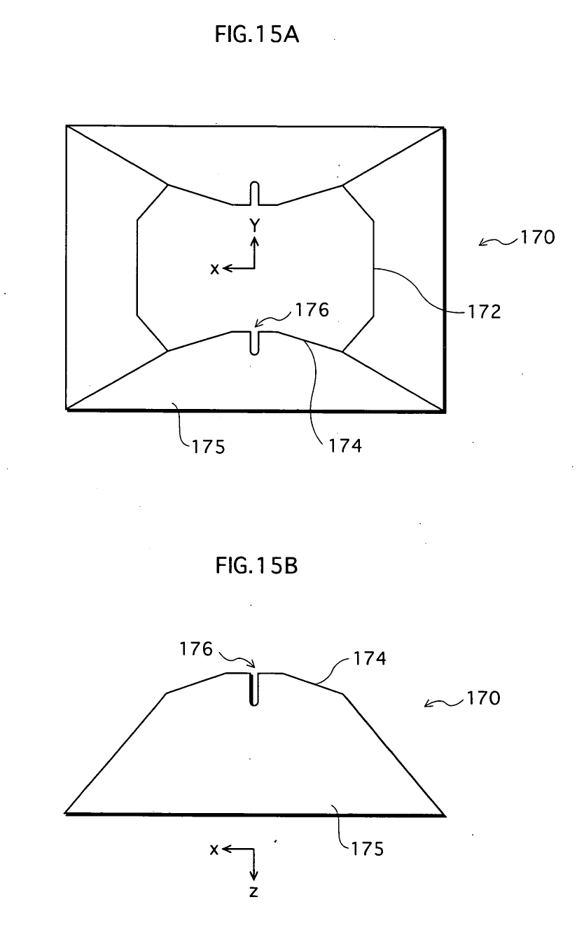

(7) In an internal magnetic shield 170 shown in FIGS. 15A and 15B, each short edge 172 is formed in the shape of an inverted trapezoid that drops toward the electron gun. The internal magnetic shield 170 has long side plates 175 which each include a long edge 174 that is formed in the shape of a trapezoid that rises toward the panel. Each long side plate 175 has a slit 176 that extends substantially from the center of the long edge 174 toward the panel, and is approximately 3 mm in width and 20 mm in length (depth) . With this construction, it is possible to reduce the amount of electron beam mislanding in the horizontal direction, in particular, the amount of mislanding at the corners, when external magnetic fields are produced to influence the color cathode ray tube in the tube axis direction and in the horizontal direction.

It should be noted here that such a slit may be formed in the internal magnetic shield 28, 110, 120, 130, 140, 150, or 160, as well as in the internal magnetic shield 170.

(8) The combinations of the shapes of the short and long edges are not limited to the above-listed ones, but may be any combinations of the shapes adopted in the internal magnetic shields 28, 110, 120, 130, 140, 150, 160, and 170. For example, the long edge may be formed in the shape of a mountain, more specifically in the shape of an obtuse-angled isosceles triangle as shown in FIG. 2, and at the same time, the short edge may be formed in the shape of a valley, more specifically in the shape of character “U” (FIGS. 10A and 10B) or “V” (FIGS. 11A and 11B). Also, the long edge may be formed in the shape of a mountain, more specifically in the shape of an obtuse-angled isosceles triangle, and at the same time, the short edge may be formed in the shape of a valley, more specifically (although not illustrated) in the shape of an arc that drops toward the electron gun.

It should be noted here that to ensure the symmetry property in the electron beam mislanding with reference to the tube axis, the shape of the short side plates is symmetrical on either side of an X-Z plane and the shape of the long side plates is symmetrical on either side of a Y-Z plane in the internal magnetic shields 110, 120, 130, 140, 150, 160, and 170 of the modifications, as well as in the internal magnetic shield 28 of the present embodiment.

It should also be noted here that at the rim of the small diameter opening, the height of the internal magnetic shield in the tube axis direction from the hypothetical plane (X-Y plane) decreases gradually from the top of the long edge in the shape of a mountain to the bottom of the short edge in the shape of a valley. It should be noted here that the phrase “at the rim of the . . . the height . . . decreases gradually . . . the short edge in the shape of a valley” means that the height does not increase at least halfway through from the top of the long edge to the bottom of the short edge, that is to say, the section between the top of the long edge to the bottom of the short edge may partially include a section where the height is constant. Accordingly, the construction indicated by the phrase “at the rim of the . . . the height . . . decreases gradually . . . the short edge in the shape of a valley” includes, for example, a construction in which the long edge is formed in the shape of a staircase as shown in FIGS. 12A and 12B. In essence, the long edge is in the shape of a mountain over the entire length thereof, and the short edge is in the shape of a valley over the entire length thereof.

### INDUSTRIAL APPLICABILITY

As described above, the cathode ray tube of the present invention is suitable for a color cathode ray tube that requires reduction of the amount of color drifts caused by electron beam mislanding.

1. A cathode ray tube comprising:
a glass bulb that is formed by joining a substantially rectangular panel with a funnel that houses an electron gun in a neck thereof; and
an internal magnetic shield that is substantially in a shape of a hollow truncated pyramid which is rectangular in a cross section, the internal magnetic shield being housed in the glass bulb such that a small diameter opening of the internal magnetic shield faces toward the electron gun, wherein
in the internal magnetic shield, a first short edge and a second short edge are arranged to face each other across the small diameter opening, and each short edge is in a shape of a valley that drops toward the panel over an entire length thereof, and a first long edge and a second long edge are arranged to face each other across the small diameter opening, and each long edge is in a shape of a mountain that rises toward the electron gun over an entire length thereof.

2. The cathode ray tube of claim 1, wherein
the internal magnetic shield is structured such that in terms of a height of the internal magnetic shield from a plane that is perpendicular to a tube axis of the cathode ray tube and includes a point at an intersection of an inner surface of the panel with the tube axis, tops of the long edges in the shape of the mountain have a largest height, points where long edges meet short edges have a smaller height than the tops of the long edges, and bottoms of the short edges in the shape of the valley have a smaller height than the points where the long edges meet the short edges.

3. The cathode ray tube of claim 2, wherein
at a rim of the small diameter opening, the height of the internal magnetic shield from the plane decreases gradually from the tops of the long edges to the bottoms of the short edges.

4. The cathode ray tube of claim 1, wherein
the shape of the valley is symmetrical on either side of a center of each of the first and second short edges, and the shape of the mountain is symmetrical on either edge of a center of each of the first and second long edges.

5. The cathode ray tube of claim 1, wherein
each short edge is continuous to each long edge at each end thereof.

6. The cathode ray tube of claim 1, wherein
each of the first and second short edges is in a shape of an inverted trapezoid, a character “U”, a character “V”, or an arc as the shape of the valley, and each of the first and second long edges is in a shape of an obtuse-angled isosceles triangle as the shape of the mountain.

7. The cathode ray tube of claim 1, wherein
a first long edge plate including the first long edge and a second long edge plate including the second long edge are arranged to face each other, and a first short edge plate including the first short edge and a second short edge plate including the second short edge are arranged to face each other, so that the internal magnetic shield is substantially in the shape of the hollow truncated pyramid, and
each of the first and second long edge plates has a slit that extends from a center of each of the first and second long edges toward the panel.

8. The cathode ray tube of claim 1 further comprising:
a rectangular frame that supports the internal magnetic shield at an end of the internal magnetic shield where a large diameter opening is formed; and
a tension mask that is supported by the rectangular frame, wherein
a phosphor screen, which is composed of red, green, and blue phosphors that are arranged to form vertical stripes, is formed on the inner surface of the panel.
